(19) United States
(12) Patent Application Publication
(10) Pub. No.: US 2025/0325440 A1
(43) Pub. Date: Oct. 23, 2025

(54) Sexual stimulation device

(71) Applicant: Dongguan Pinchen Industrial Design Co., Ltd., Dongguan (CN)

(72) Inventor: Qinling WANG, Heyuan (CN)

(21) Appl. No.: 18/903,202

(22) Filed: Oct. 1, 2024

(30) Foreign Application Priority Data
Apr. 19, 2024 (CN) 202420835226.2

(51) Int. Cl. A61H 19/00; A61H 7/00

(52) U.S. Cl. CPC A61H 19/34; A61H 7/005; A61H 19/44; A61H 2201/1669

(57) ABSTRACT

The present disclosure provides a sexual stimulation device including: a main body comprising a handle portion; an elongated arm configured to be slidably engaged with a vagina of a female; a pair of clamping fingers configured to substantially remain outside the vagina while the elongated arm being inserted into the vagina; and a driving structure arranged in the main body and coupled to the pair of clamping fingers, wherein the pair of clamping fingers is driven by the driving structure and is switchable between a clamping stage and a releasing stage, the clamping fingers move towards each other to cooperatively clamp a portion of human body which is around the vagina in the clamping stage, while the fingers move away from each other to release the clamped portion of human body in the releasing stage.

### RELATED APPLICATIONS

This application claims the benefit of priority to Chinese Patent Application Number 202420835226.2 filed on Apr. 19, 2024, in the China National Intellectual Property Administration. The entire contents of the above-identified application are hereby incorporated by reference.

### TECHNICAL FIELD

The present disclosure relates to the technical field of sexual stimulation, and in particular, to a sexual stimulation device.

### BACKGROUND

With the development and progress of society, a telescopic arm is usually provided for the sexual stimulation devices. However, the telescopic arm has a single function, and when performing auxiliary massage, the massage effect is poor and cannot meet the massage needs of the user.

### BRIEF DESCRIPTION OF DRAWINGS

Implementations of the present disclosure will now be described, by way of embodiment, with reference to the attached figures.

FIG. 1 is a three-dimensional structural diagram of a sexual stimulation device according to a first embodiment of the present disclosure.

FIG. 2 is a front view of the sexual stimulation device shown in FIG. 1.

FIG. 3 is a cross-sectional view of the sexual stimulation device shown in FIG. 1.

FIG. 4 is a three-dimensional structural diagram of the sexual stimulation device shown in FIG. 1 with a covering being removed.

FIG. 5 is a partial three-dimensional structural diagram of the sexual stimulation device shown in FIG. 4.

FIG. 6 is a three-dimensional structural diagram of a driving structure of the sexual stimulation device shown in FIG. 5.

FIG. 7 is a three-dimensional structural diagram of the driving structure of the sexual stimulation device from another viewpoint.

FIG. 8 is an exploded view of the driving structure of the sexual stimulation device.

FIG. 9 is a partial three-dimensional structural diagram of a main body of the sexual stimulation device shown in FIG. 1.

FIG. 10 is a partial three-dimensional structural diagram of the main body and the driving structure of the sexual stimulation device shown in FIG. 1.

FIG. 11 is a cross-sectional view of the sexual stimulation device according to a second embodiment of the present disclosure.

FIG. 12 is an exploded view of the sexual stimulation device shown in FIG. 11 with the covering being removed.

FIG. 13 is a cross-sectional view of the sexual stimulation device according to a third embodiment of the present disclosure.

FIG. 14 is a three-dimensional structural diagram of the sexual stimulation device shown in FIG. 13 with the covering being removed.

FIG. 15 is an exploded schematic view of the sexual stimulation device shown in FIG. 13.

### DETAILED DESCRIPTION

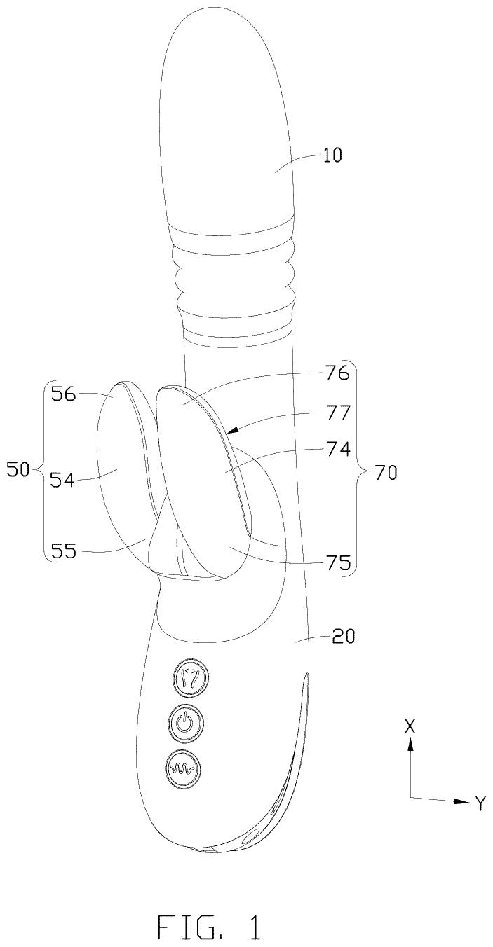

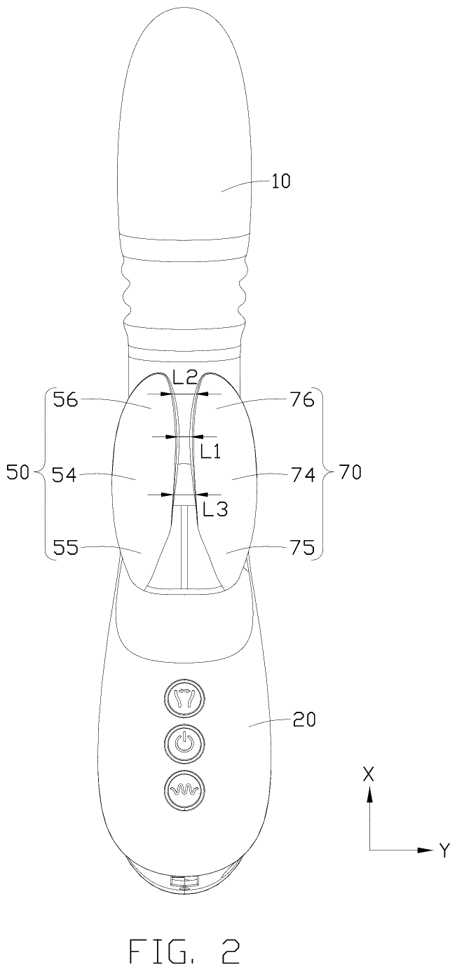

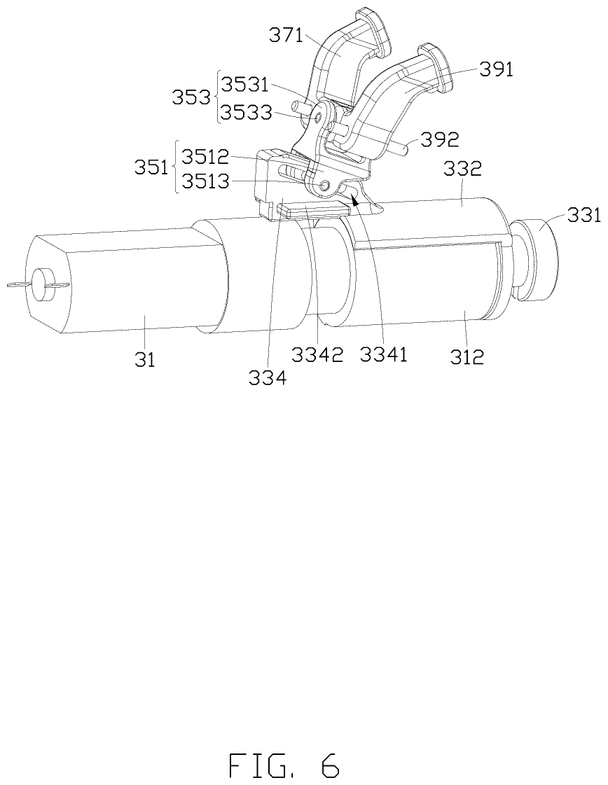

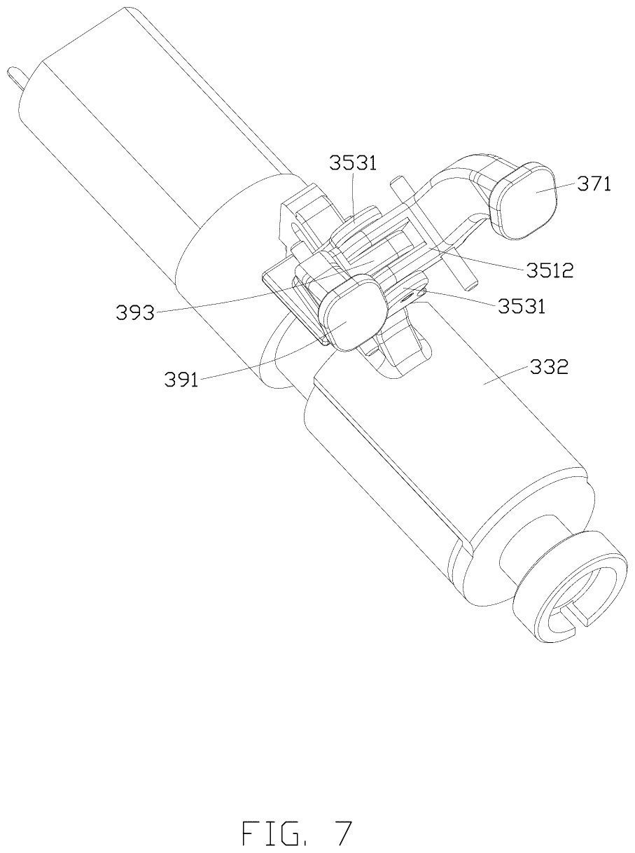

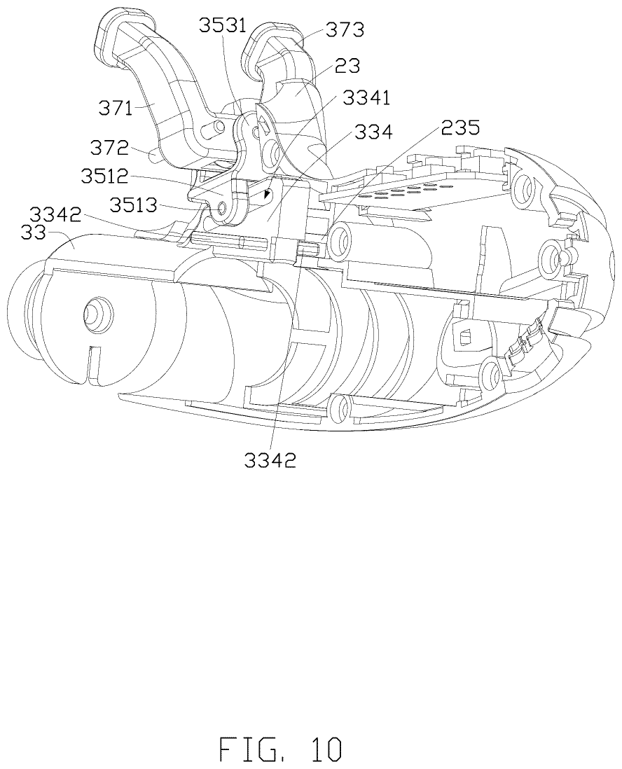

Referring to FIG. 1 to FIG. 10, the present disclosure provides a sexual stimulation device 100, which is configured for being partly inserted into an vagina of a female for sexual stimulation. In particular, the sexual stimulation device 100 includes a main body 20, an elongated arm 10, a driving structure 30, a pair of clamping fingers, and a control circuit board 90. The elongated arm 10, the pair of clamping fingers are arranged at one end of the main body 20. The driving structure 30 and the control circuit board 90 are accommodated in the main body 20. The driving structure 30 is coupled to the elongated arm 10, the pair of clamping fingers, and the control circuit board 90. Therefore, under the control of the control circuit board 90, the driving structure 30 is capable of driving the elongated arm 10 to do a telescoping motion and/or swinging motion and driving the pair of clamping fingers to do a clamping motion and/or a releasing motion. In this embodiment, the pair of clamp fingers includes a first clamping finger 50 disposed at a side of the elongated arm 10 and a second clamping finger 70 spaced and opposite to the first clamping finger 50.

In this embodiment, both of the elongated arm and the pair of clamping fingers are driven by a same driving motor 31 of the driving structure 30 described later. The elongated arm 10 is movable along a longitudinal direction X of the sexual stimulation device 100. The first clamping finger 50 and the second clamping finger 70 are capable of swinging along a lateral direction Y of the sexual stimulation device 100. Therefore, the sexual stimulation device 100 is switchable between a clamping motion and a releasing motion. In the clamping motion, the clamping fingers move towards each other so as to cooperatively clamp a portion of human body which is around the vagina. In the releasing motion, the clamping fingers move away from each other to release the clamped portion of human body.

The elongated arm 10 is driven to stretch away the main body 20 while the pair of clamping fingers is in one of the clamping motion and the releasing motion, such as in the clamping motion. The elongated arm 10 is driven to draw back to the main body 20 while the pair of clamping fingers is in another one of the clamping motion and the releasing motion, such as in the releasing motion.

Referring to FIG. 1 to FIG. 5, the elongated arm 10 is configured for protruding from the main body 20 and extending along the longitudinal direction of the sexual stimulation device 100. The elongated arm 10 is configured for moving telescopically relative to the main body 20 and slidably engages with the vagina of the female.

In this embodiment, the elongated arm 10 is a cylindrical structure, and includes a body 11, a first motor 13, and a connecting member 15.

The body 11 is a hollow cylindrical structure with an opening at one side, and a mounting space 110 is defined in the body 11 along the longitudinal direction X of the sexual stimulation device 100. In this embodiment, the body 11 is made of a first material with a first hardness, that is, the body 11 is made of a hard material

The first motor 13 is received in the mounting space 110 and engaged with an inner wall of the body 11. In this embodiment, the first motor 13 is a vibrating motor.

The connecting member 15 includes a fixing portion 151 and a connected portion 153 protruding from one end of the fixing portion 151. The fixing portion 151 is inserted into the body 11 via the opening of the body 11. The fixing portion 151 is fixedly engaged with the body 11 at the opening location. The connected portion 153 has a cylindrical structure, a diameter of the connected portion 153 is larger than that of the fixing portion 151, so that the connected portion 153 and the fixing portion 151 form a step structure. A connection groove 1531 is defined in one end of the connected portion 153 away from the fixing portion 151 and configured for installing the driving structure 30. One end of the connected portion 153 away from the fixing portion 151 is fixedly connected to the main body 20. In this embodiment, the connecting member 15 is made of a second material with a second hardness, and the second hardness is less than the first hardness. For example, the connecting member 15 is made of a soft material.

In one embodiment, a length of the elongated arm 10 is much longer than that of the clamp fingers. For example, the length of the elongated arm 10 may be in a range from 3 cm to 30 cm, and specifically, may be, for example, 3 cm, 5 cm, 8 cm, 10 cm, 15 cm, 20 cm, 25 cm, 30 cm, etc., which are not limited here.

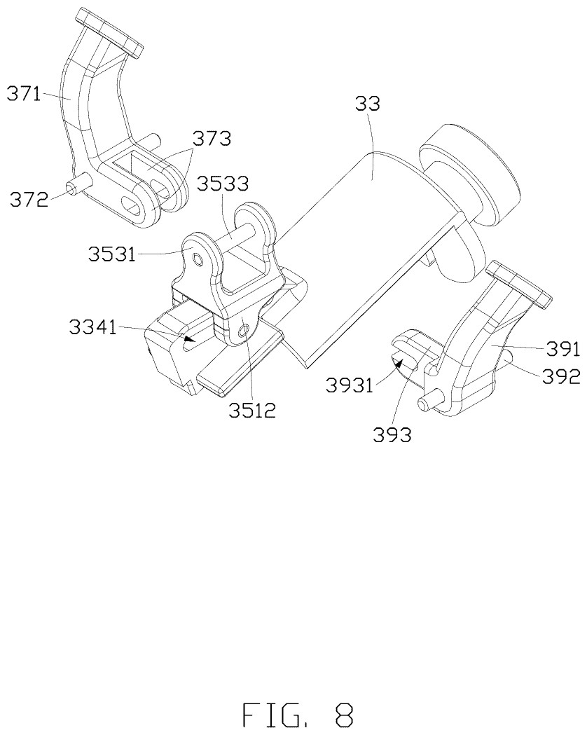

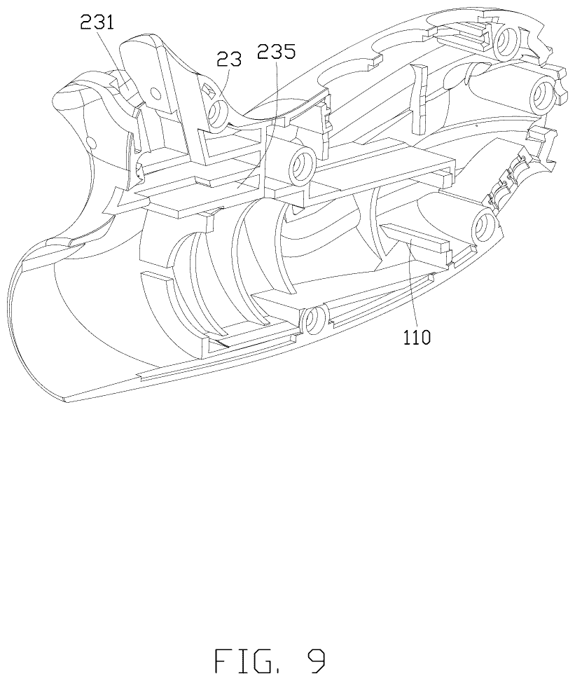

Referring to FIG. 1, FIG. 8 and FIG. 9, the main body 20 is a cylindrical structure, and includes a first receiving portion 21 configured for accommodating the driving structure 30 and the control circuit board 90. The main body 20 has a handle portion for users, and an external contour of the main body 20 can be adjusted according to requirements.

Referring to FIG. 9, a supporting portion 23 protrudes from an end of the main body 20 and extends along the lateral direction Y of the sexual stimulation device 100. The supporting portion 23 is configured for supporting a part of the driving structure 30. The supporting portion 23 includes an opening 231 in air communication with the first receiving portion 21. The driving structure 30 is partly arranged in the supporting portion 23 and protrudes out of the main body 20 through the opening 231. A guide rail 235 is formed on an inner wall of the first receiving portion 21 of the main body 20 for guiding the driving structure 30.

In this embodiment, the main body 20 includes a protrusion 22 adjacent to the elongated arm 10, the pair of clamping fingers is arranged on the protrusion 22.

In this embodiment, the main body 20 is made of the first material with the first hardness.

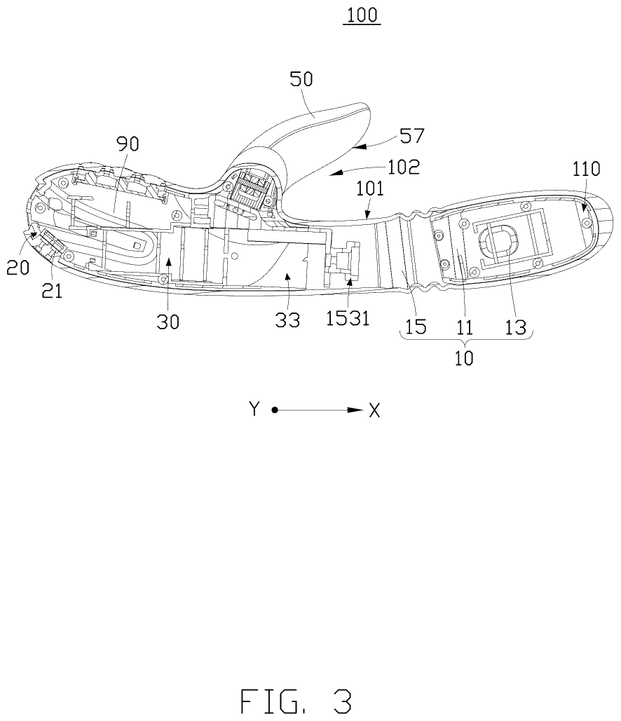

Referring to FIG. 3 to FIG. 8, the driving structure 30 is accommodated in one of the main body 20 and the elongated arm 10 and coupled with the pair of clamping fingers. The driving structure 30 is configured for driving the elongated arm 10, the pair of clamping fingers to do motions. The driving structure 30 includes a driving motor 31, a telescopic sleeve 33, a slider 35, a first transmission member 37 and a second transmission member 39.

The driving motor 31 is fixedly arranged in the first receiving portion 21 of the main body 20. The driving motor 31 includes a telescopic portion 312 capable of extending and retracting relative to the main body 20. The telescopic portion 312 protrudes from the opening of the main body 20 and is partly received into the connection groove 1531, so that the telescopic portion 312 is coupled with the connecting member 15.

The telescopic sleeve 33 is sleeved on the telescopic portion 312 of the driving motor 31 and coupled to the elongated arm 10, so that under the drive of the driving motor 31, the telescopic portion 312 extends and retracts relative to the main body 20. The extending and retracting motion of the telescopic portion 312 drive the telescopic sleeve 33 to do extending and retracting motion along the longitudinal direction X of the sexual stimulation device 100. The telescopic sleeve 33 also drives the connecting member 15 to move together with the telescopic sleeve 33, so that the connecting member 15 extends and retracts relative to the main body 20 under the drive of the driving motor 31.

The telescopic sleeve 33 includes an engaging portion 331, a fixed connecting portion 332 formed by protruding and extending outwards from one end of the engaging portion 331, and an entraining portion 334 formed by protruding and extending outwards from the fixed connected portion 332 at a side which is away from the engaging portion 331. The engaging portion 331 may be roughly in a shape of a cylindrical, one end of the engaging portion 331 is accommodated in the connection groove 1531 of the connecting member 15, the engaging portion 331 is snap-fitted in the opening of the connecting member 15, and another end of the engaging portion 331 is fixedly connected to the telescopic portion 312, so that the engaging portion 331 can drive the connecting member 15 to do extending and retracting motion. The fixed connected portion 332 is formed by protruding and extending vertically along the edge of the semicircle of the engaging portion 331, and the cross section of the fixed connected portion 332 is arc-shaped. The fixed connected portion 332 is fixedly arranged on the telescopic portion 312 so as to move together with the telescopic portion 312.

The entraining portion 334 is arranged at an end of the fixed connected portion 332 which is away from the engaging portion 331. The entraining portion 334 is protruded and extended in a direction perpendicular to the fixed connected portion 332. The entraining portion 334 may be roughly in a shape of a triangular, and a guiding portion 3342 is formed on two side walls of the entraining portion 334. The guiding portion 3342 is accommodated in the guide rail 235 of the main body 20, so that the guiding portion 3342 of the telescopic sleeve 33 moves linearly along the guide rail 235 of the main body 20 under the driving of the driving motor 31. An inclined sliding hole 3341 is defined in the upper part of the guiding portion 3342 of the entraining portion 334. The sliding hole 3341 is an inclined hole, which gradually inclines upward from a connected portion with the fixed connected portion 332 toward a direction away from the fixed connected portion 332.

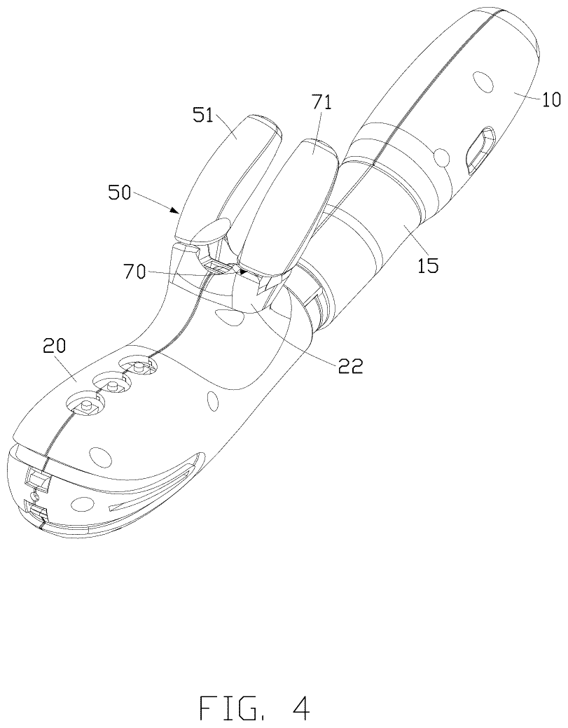

Referring to FIG. 4 to FIG. 7, the slider 35 is movably arranged on the entraining portion 334 and is capable of sliding along the sliding hole 3341. The slider 35 is coupled to the first clamping finger 50 via the first transmission member 37 and to the second clamping finger 70 via the second transmission member 39. The slider 35 includes a sliding connected portion 351, and a mounting portion 353 vertically extending from the sliding connected portion 351. The sliding connected portion 351 is movably arranged in the sliding hole 3341. The sliding connected portion 351 maybe U-shaped, and includes two first protrusions 3512 located at sides of the slider 35 and a first rotation shaft 3513. The first rotation shaft 3513 sequentially extends through one first protrusion 3512, the sliding hole 3341, and another first protrusion 3512, so that a part of the rotation shaft 3513 is slidable in the sliding hole 3341. When the telescopic portion 312 telescopes, the guiding portion 3342 of the telescopic sleeve 33 moves linearly along the guide rail 235 of the main body 20, and the entraining portion 334 of the telescopic sleeve 33 drives the slider 35 to telescope. At this time, the inclined surface of the sliding hole 3341 is contacted with the first rotation shaft 3513, and the inclined surface pushes the first rotation shaft 3513, so that the slider 35 moves towards the elongated arm 10 along the longitudinal direction X of the sexual stimulation device 100. The height of the inclined surface of the sliding hole 3341 gradually increases, so that the first rotation shaft 3513 slides upward along the inclined surface and the slider 35 moves upward. On the contrary, when the slider 35 moves away from the elongated arm 10 along the longitudinal direction X of the sexual stimulation device 100, the first rotation shaft 3513 slides downward along the inclined surface and the slider 35 moves downward. Further, the slider 35 slides along the sliding holes 3341 and reciprocates up and down relative to the main body 20. The mounting portion 353 includes two second protrusions 3531 and a second rotation shaft 3533. The extension directions of the two second protrusions 3531 are opposite to those of the two first protrusions 3512, and the arrangement direction of the two second protrusions 3531 is approximately perpendicular to that of the two first protrusions 3512, and the two second protrusions 3531 are staggered with the two first protrusions 3512, that is, the first protrusions 3512 and the second protrusions 3531 are not located on the same plane. The second rotation shaft 3533 extends through the two second protrusions 3531.

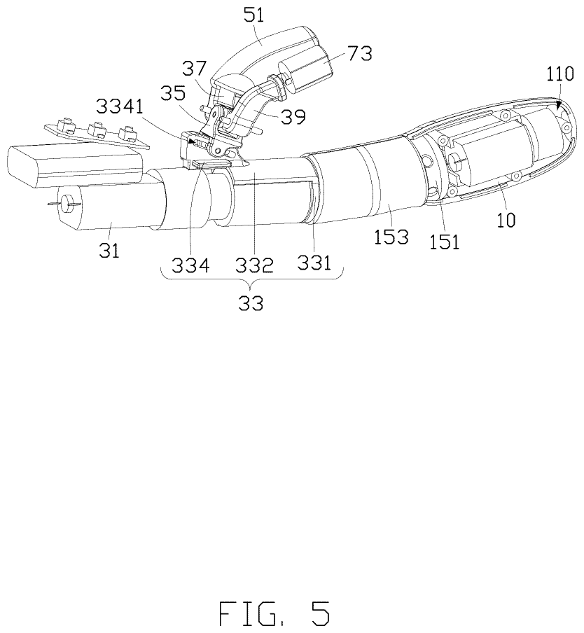

Referring to FIG. 5 to FIG. 7, the first transmission member 37 and the second transmission member 39 are movably installed on the second rotation shaft 3533. The first transmission member 37 includes a first transmission portion 371 and a first shaft 372 movably arranged on the first transmission portion 371. The first transmission portion 371 has an L-shaped structure, one end of the first transmission portion 371 is rotatably coupled with a first shaft portion 372. he first shaft portion 372 is fixedly connected to the supporting portion 23 of the main body 20. The first transmission member 37 further includes two first rotation portions 373 vertically protruding from both sides of one end of the first transmission portion 371. The two first rotation portions 373 are spaced and arranged in parallel with each other. The two first rotation portions 373 are located between the second protrusions 3531. The third rotation shaft 375 extends through the two first rotation portions 373, so that the two first rotation portions 373 are rotatably arranged between the second protrusions 3531.

The second transmission member 39 includes a second transmission portion 391 and a second shaft portion 392 movably coupled to the second transmission portion 391. The second transmission portion 391 is an L-shaped, one end of the second transmission portion 391 is rotatably arranged on the second shaft portion 392, and the second shaft portion 392 is fixedly connected to the supporting portion 23 of the main body 20. The second transmission member 39 further includes a second rotation portion 393 protruding from a center position of one end of the second transmission portion 391 and located between the two first rotation portions 373. The second rotation portion 393 includes a groove 3831 defined on one end of the second rotation portion 393, and the third rotation shaft 375 extends through the groove 3831 of the second rotation portion 393, so that the second transmission member 39 is movably installed between the second protrusions 3531.

In this embodiment, the third rotation shaft 375 extends through one second protrusion 3531, one first rotation portion 373, the groove 3831 of the second rotation portion 393, another first rotation portion 373, and another second protrusion 3531, so that the second transmission member 39 and the first transmission member 37 do swing motions via the third rotation shaft 375. Therefore, the sexual stimulation device 100 is switchable between a clamping motion and a releasing motion by the second transmission member 39 and the first transmission member 37.

Referring to FIG. 1 to FIG. 4, the first clamping finger 50 and the second clamping finger 70 are configured for cooperatively clamping a portion of human body between the first clamping finger 50 and the second clamping finger 70. the first clamping finger 50 and the second clamping finger 70 are substantially arranged in parallel and symmetrically relative to a center plane of the sexual stimulation device 100 along the longitudinal direction X. In this embodiment, at the condition that the elongated arm 10 is uninserted into the vagina, the first clamping finger 50 and the second clamping finger 70 are in contact with each other in the clamping motion.

The first clamping finger 50 and the second clamping finger 70 are rod-shaped, each of the first clamping finger 50 and the second clamping finger 70 includes a shell 51, 71 and a second motor 53, 73 accommodated in the shell 51. The shells 51 and 71 are sleeved on the first transmission portion 371 of the corresponding first transmission member 37 and the second transmission portion 391 of the second transmission member 39, respectively. In this embodiment, the shells 51, 71 are made of the second material with the second hardness, that is, the shells 51, 71 are made of a soft material.

In this embodiment, the first clamping finger 50 includes a first contact portion 54, a first end portion 55 coupled to the main body 20, and a second end portion 56 at a free end of the first clamping finger 50 which is opposite to the first end portion 55. The second clamping finger 70 includes a second contact portion 74, a third end portion 75 coupled to the main body 20, and a fourth end portion 76 at a free end of the second clamping finger 70 which is opposite to the third end portion 75.

In this embodiment, when the driving structure 30 does not drive the pair of clamping fingers, a gap defined between the first contact portion 54 and the second contact portion 74 is L1, a gap defined between the first end portion 55 and the third end portion 75 is L2, a gap defined between the second end portion 56 and the fourth end portion 76 is L3, wherein L1 is smaller than anyone of L2 and L3.

In this embodiment, the pair of clamping fingers is obliquely arranged relative to the elongated arm 10, a portion of human body is receivable in an accommodation space 102 defined by the elongated arm 10 and the pair of clamping fingers

In this embodiment, the pair of clamping fingers includes a first clamping finger 50 and a second clamping finger 70, at least one of the first clamping finger 50 and the second clamping finger 70 is capable of vibrating movement.

Further, each of the first clamping finger 50 and the second clamping finger 70 has an inner surface 57, 77 facing the elongated arm 10. The inner surfaces are arc-shaped, so that the first clamping finger 50 and the second clamping finger 70 are more comfortable when contacting with the skin of the female.

Referring to FIG. 1, the sexual stimulation device 100 further includes a covering member 101, which covers the main body 20, the first clamping finger 50, the second clamping finger 70, and the elongated arm 10. The covering member 101 is made of a third material having a third hardness, the third hardness is smaller than the second hardness.

In this embodiment, the second hardness is less than the first hardness, and the third hardness is less than the second hardness. The main body 20 and the body 11 of the first hardness are made of a hard material, the connecting member 15 and the shells 51 and 71 of the second hardness are made of a soft material, and the covering 101 of the third hardness is made of a soft material more flexible than that of the connecting member 15 and the shells 51 and 71.

The control circuit board 90 is connected to the driving motor 31, the first motor 60, and the second motors 53 and 73 to control the driving motor 31, the first motor 60, and the second motors 53 and 73.

When the sexual stimulation device 100 is operated, under the control of the control circuit board 90, the first motor 60 and the driving motor 31 are started, the first motor 60 vibrates in the elongated arm 10, at the same time, under the drive of the driving motor 31, the telescopic portion 312 extends and retracts relative to the main body 20, the telescopic portion 312 drives the telescopic sleeve 33 to move, and the telescopic sleeve 33 drives the connecting member 15 to move, so that the connecting member 15 can do the extending and retracting motion.

Meanwhile, the guiding portion 3342 of the telescopic sleeve 33 moves linearly along the guide rail 235 of the main body 20, the slider 35 reciprocates telescopic together with the telescopic sleeve 33 and moves along the sliding hole 3341 and reciprocating up and down relative to the main body 20. The second rotation shaft 3533, arranged on the slider 35, likewise pulls and pushes the two first rotation portions 373 of the first transmission member 37 and the second rotation portion 393 of the second transmission member 39 in an upward and downward reciprocating motion. So that when the two first rotation portions 373 of the first transmission 37 and the one second rotation portion 393 of the second transmission 39 are pulled downward, the first transmission member 37 and the second transmission member 39 move relative to each other and are close to each other. When the two first rotation portions 373 of the first transmission member 37 and one second rotation portion 393 of the second transmission member 39 are pushed upward, the first transmission member 37 and the second transmission member 39 move in opposite directions and move away from each other. Therefore, the clamping and/or releasing motion is achieved by the toward and opposite swinging motions of the first transmission member 37 and the second transmission member 39. In addition, the control circuit board 90 controls the second motors 53, 73 to vibrate in the clamping finger, so that the first clamping finger 50 and the second clamping finger 70 can vibrate while clamping and/or releasing.

### Second Embodiment

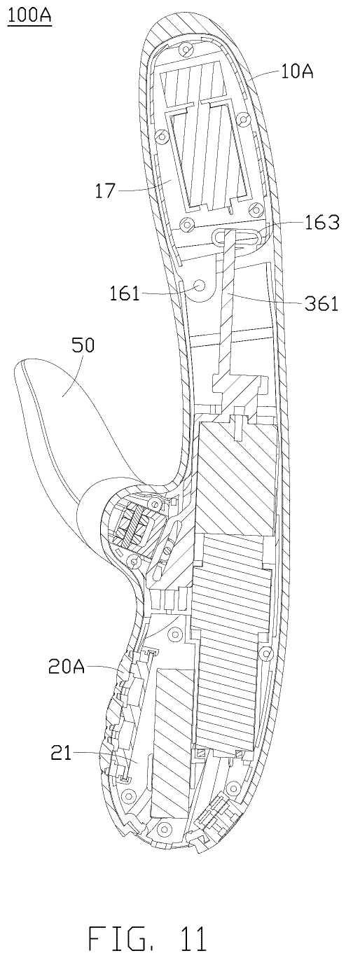

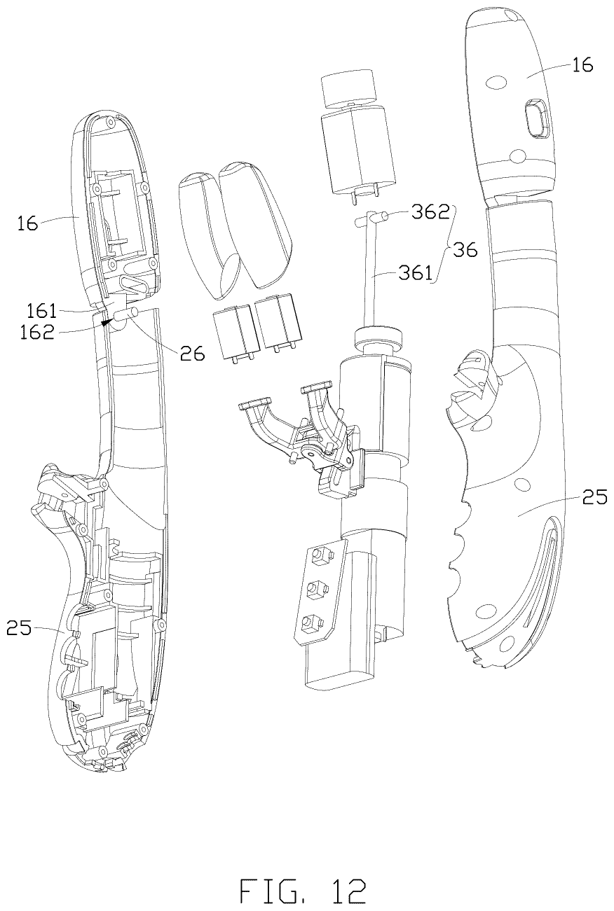

Referring to the FIG. 11 to FIG. 12, the sexual stimulation device 100A of the second embodiment differs from the sexual stimulation device 100 of the first embodiment in the structure of the elongated arm 10A and the driving structure 30A.

In this embodiment, the elongated arm 10A is rotatably connected to the main body 20A. The main body 20A includes two first shell bodies 25. The two first shell bodies 25 are attached to each other to define a first receiving portion 21, and an opening.

The elongated arm 10A includes two second housings 16, and the two second housings 16 are attached to form a second receiving portion 17. One side, of the second housing 16 is provided with an telescopic portion 161, and the telescopic portion 161 defines a through hole 162 configured for allowing the fixing shaft 26 to pass through and rotate, so that the elongated arm 10A can be rotatably connected to the main body 20A.

Further, the second housing 16 includes a fitting groove 163 at the inner wall thereof. The telescopic sleeve 33A of the driving structure 30A further includes a pusher 36 based on the structure of the telescopic sleeve 33 in the first embodiment. The pusher 36 is arranged at one end of the engaging portion 331 which is away from the driving motor 30 along the telescopic direction of the telescopic portion 312. The pusher 36 includes a stem 361 and a fixing portion 362 coupled to an end of the stem 361 which is away from the engaging portion 331. The fixing portion 362 is roughly perpendicular to the stem 361.

The fixing portion 362 is movably disposed in the fitting groove 163 of the elongated arm 10A. When the telescopic sleeve 312 moves along the longitudinal direction X of the sexual stimulation device 100A, the push member 36 pushes the elongated arm 10A to move relative to the main body 20A.

### Third Embodiment

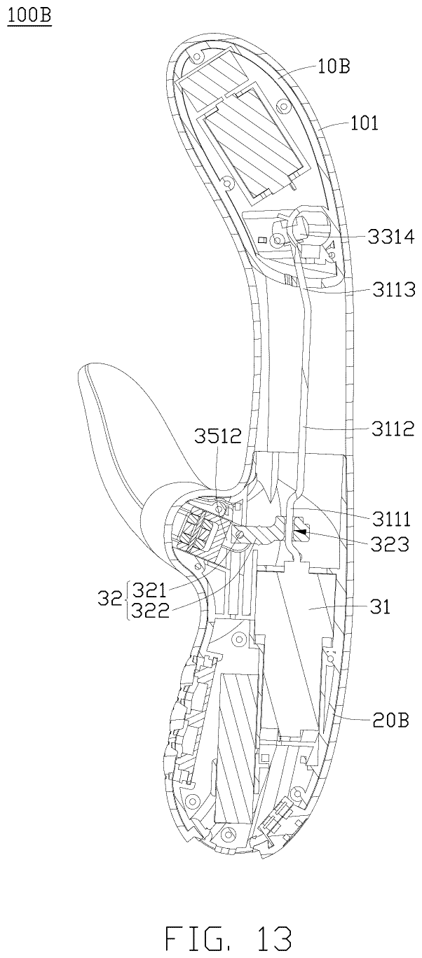

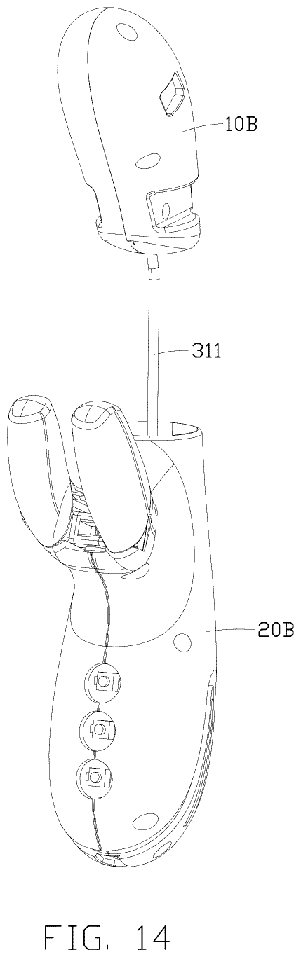

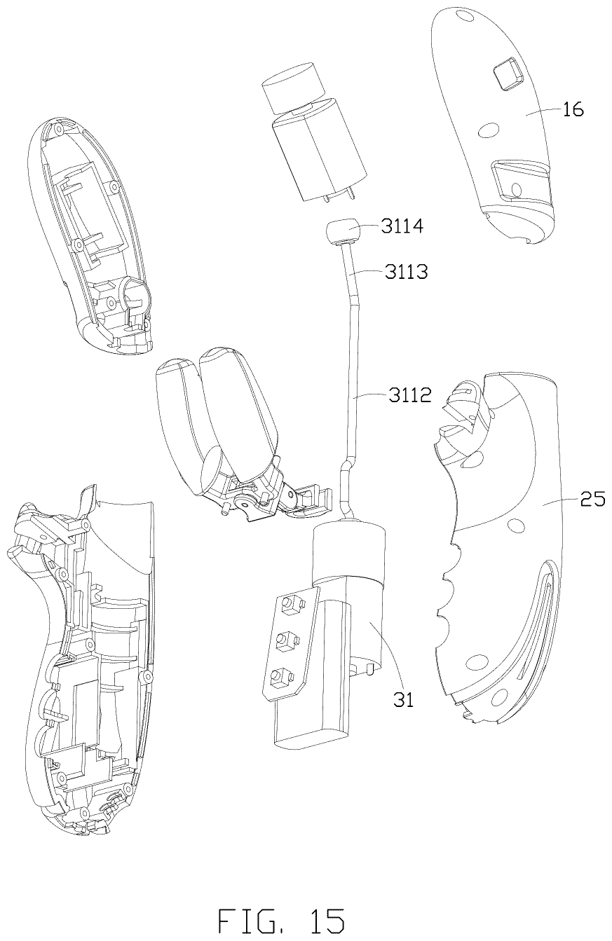

Referring to the FIG. 13 to FIG. 15, the sexual stimulation device 100B of the third embodiment differs from the sexual stimulation device 100A of the first embodiment at a driving structure 30B.

In this embodiment, the driving structure 30B includes a driving motor 31, a pull rod 32, and a fixing portion 3114.

The driving motor 31 is fixedly arranged in the first receiving portion 21 of a main body 20B, the driving motor 31 includes a rotation shaft 311 extending from one end of the driving motor 31 to an elongated arm 10B. The rotation shaft 311 includes a first portion 3111, a second portion 3112, and a third portion 3113 arranged in sequence. The middle portion of the first portion 3111 is not collinear with the second portion 3112, such that the middle portion of the first portion 3111 is offset from the center line of the driving motor 31. The second portion 3112 is arranged to overlap a center line of the driving motor 31. In this embodiment, the second portion 3112 is linear. The third portion 3113 is arranged obliquely relative to the second portion 3112 and forms an angle with the first portion 3111.

A fixing portion 3114 is also disposed at an end of the third portion 3113 away from the second part 3112. The fixing portion 3114 is fixedly disposed in the mounting groove of the elongated arm 10B. When the driving motor 31 drives the rotation shaft 311 to rotate, the fixing portion 3114 can drive the moving part of the elongated arm 10B to swing.

Further, the pull rod 32 includes a first end portion 321 and a second end portion 322 arranged opposite the first end portion 321, where the first end portion 321 is rotatably connected to the mounting portion 353, and the second end portion 322 is connected to the first portion 3111 of the rotation shaft 311.

Specifically, the first end portion 321 is disposed between the two first protrusions 3512 and provided with a through hole. In this way, the first rotation shaft 311 sequentially extends through one first protrusion 3512, the through hole of the first end 321, and another first protrusion 3512, so that the sliding connected portion 351 is rotatably connected to the first pull rod 32.

A second through hole 323 is formed in the second end portion 322, the second through hole 323 is configured for the rotation shaft 311 to pass through, and at least a part of the middle part of the first portion 3111 of the rotation shaft 311 is accommodated in the second through hole 323, In this way, when the driving motor 31 is started, the rotation shaft 311 can be driven to rotate, and since the middle part of the first portion 3111 of the rotation shaft 311 deviates from the central line of the driving motor 31, In this way, with rotation of the rotation shaft 311, the slider 35 can be driven to move up and down by the pull rod 32, so that the two first rotation portions 373 of the first transmission member 37 and the one second rotation portion 393 of the second transmission member 39 are pulled up and down and pushed.

In this embodiment, the second body 16 of the elongated arm 10B is spaced apart from the first body 25 of the main body 20B by a certain distance so that the elongated arm 10B can swing relative to the main body 20B in a sufficient space. the covering 101 covers on the outer side of the elongated arm 10B and the main body 20B and connects the 10B to the main body 20B.

1. A sexual stimulation device which is insertable into a vagina of a female along an insertion direction, the sexual stimulation device comprising:
a main body comprising a handle portion, the handle portion comprising a connection end;
an elongated arm extending from the connection end along the insertion direction of the sexual stimulation device and configured to be slidably engaged with the vagina of the female;
a pair of clamping fingers extending from the connection end and configured to substantially be outside the vagina while the elongated arm is inserted into the vagina, wherein orthographic projections of the pair of clamping fingers in the insertion direction at least partially overlaps with the elongated arm; and
a driving structure arranged in the main body and coupled to the pair of clamping fingers,
wherein the pair of clamping fingers is driven by the driving structure and is reciprocally switchable between a clamping stage and a releasing stage, the clamping fingers move towards each other to cooperatively clamp a portion of human body which is around the vagina in the clamping stage, and the fingers move away from each other to release the clamped portion of human body in the releasing stage.

2. The sexual stimulation device according to claim 1, wherein the elongated arm comprises a stimulation portion arranged at a distal end of the elongated arm away from the main body, and the stimulation portion is configured for moving telescopically relative to the main body, the stimulation portion of the elongated arm is driven to move away from the main body while the clamping fingers are in one of the clamping stage and the releasing stage, and the stimulation portion of the elongated arm is driven to move towards the main body while the clamping fingers are in another one of the clamping stage and the releasing stage.

3. (canceled)

4. The sexual stimulation device according to claim 1, wherein the clamping fingers are arranged substantially in parallel, and the clamping fingers are symmetrical with respect to a plane in which the elongated arm is located,
the pair of clamping fingers comprises a first clamping finger and a second clamping finger, the first clamping finger comprises a first contact portion, a first end portion coupled to the main body, and a second end portion, the first end portion and the second end portion are located at two opposite sides of the first contact portion, the second clamping finger comprises a second contact portion, and a third end portion coupled to the main body and a fourth end portion, the third end portion and the fourth end portion are located at two opposite sides of the second contact portion, and
when the pair of clamping fingers is not driven by the driving structure, a gap between the first contact portion and the second contact portion is configured to be narrower than at least one of a gap between the first end portion and the third end portion and a gap between the second end portion and the fourth end portion.

5. The sexual stimulation device according to claim 1, wherein the pair of clamping fingers is obliquely arranged relative to the elongated arm, and an accommodation space is defined by the elongated arm and the pair of clamping fingers to accommodate a portion of human body being partly clamped and released by the pair of clamping fingers.

6. The sexual stimulation device according to claim 1, wherein the pair of clamping fingers comprises a first clamping finger and a second clamping finger, the first clamping finger and the second clamping finger are arranged along a circumferential direction of the main body, the first clamping finger comprises a first connecting end connected to the main body, the second clamping finger comprises a second connecting end connected to the main body, and a first distance from the first connecting end to an end of the main body away from the pair of clamping fingers is substantially equal to a second distance from the second connecting end to the end of the main body.

7. (canceled)

8. The sexual stimulation device according to claim 1, wherein the pair of clamping fingers comprises a first clamping finger and a second clamping finger, at least one of the first clamping finger and the second clamping finger is further configured to vibrate.

9. (canceled)

10. A sexual stimulation device comprising:
a main body comprising a handle portion,
an insertable arm configured for protruding from the main body and extending along a longitudinal direction of the sexual stimulation device;
a first clamper disposed at a side of the insertable arm,
a second clamper spaced and opposite to the first clamper, the first clamper and the second clamper being configured for cooperatively clamping a portion of human body between the first clamper and the second clamper; and
a driving mechanism accommodated in one of the main body and the insertable arm, and configured for driving the insertable arm, the first clamper and the second clamper,
wherein the driving mechanism comprises a driving motor, a first transmission shaft and a second transmission shaft coupled to the driving motor, at a least a part of the first transmission shaft is inserted into the first clamper, at least a part of the second clamper is inserted into the second clamper, and the first clamper and the second clamper are driven by the driving mechanism to swing reciprocally along a lateral direction of the sexual stimulation device.

11. The sexual stimulation device according to claim 10, wherein the main body comprises a first receiving portion, and the driving mechanism further comprises a telescopic sleeve, and a slider,
the driving motor is accommodated in the first receiving portion,
the telescopic sleeve is arranged on the driving motor and coupled to the insertable arm, the driving motor drives the telescopic sleeve to extend or retract along the longitudinal direction of the sexual stimulation device,
the slider is movably arranged on the telescopic sleeve, and the slider is coupled to the first clamper via the first transmission shaft and coupled to the second clamper via the second transmission shaft.

12. The sexual stimulation device according to claim 11, wherein the telescopic sleeve comprises an inclined sliding hole, and the slider is slidable in the sliding hole and rotatably connected to the first transmission shaft and the second transmission shaft.

13. The sexual stimulation device according to claim 12, wherein the slider comprises a sliding connected portion movably arranged in the sliding hole and a mounting portion substantially vertically extending from the sliding connected portion, wherein the mounting portion is rotatably connected to the first transmission shaft and the second transmission shaft.

14. The sexual stimulation device according to claim 13, wherein the sliding connected portion comprises two first protrusions and a first rotation shaft, the two first protrusions are respectively located at two opposite sides of the slider, the first rotation shaft sequentially extends through one of the two first protrusions, the sliding hole, and another one of the two first protrusions, and a part of the first rotation shaft is slidable in the sliding hole.

15. The sexual stimulation device according to claim 14, wherein the mounting portion comprises two second protrusions and a second rotation shaft, the two second protrusions are offset from the two first protrusions, and the second rotation shaft is arranged between the two second protrusions.

16. The sexual stimulation device according to claim 15, wherein the first transmission shaft comprises a first transmission portion and a first shaft portion movably connected to the first transmission portion,
the second transmission shaft comprises a second transmission portion and a second shaft portion movably connected to the second transmission portion,
the first transmission shaft and the second transmission shaft are located between the two second protrusions, and the second rotation shaft extends through the first transmission shaft and the second transmission shaft, and
the first shaft portion and the second shaft portion are fixed to the main body.

17. The sexual stimulation device according to claim 16, wherein the first transmission shaft includes two first rotation portions at an end of the first transmission shaft, the two first rotation portions are spaced apart from each other, and the two first rotation portions are respectively located between the two second protrusions,
the second transmission shaft includes a second rotation portion at an end of the second transmission shaft, the second rotation portion is located between the two first rotation portions, and a groove is defined in the second rotation portion,
the second rotation shaft sequentially extends through one of the two second protrusions, one of the two first rotation portion portions, the groove of the second rotation portion, another one of the two first rotation portion portions, and another one of the two second protrusions, so that the second transmission shaft and the first transmission shaft are driven to move in opposite directions and move away from each other by the second rotation shaft, and a clamping motion is achieved by the first transmission shaft and the second transmission shaft moving towards and away from each other.

18. The sexual stimulation device according to claim 16, wherein the sexual stimulation device further comprises a covering member which covers the main body, the first clamper, the second clamper, and the insertable arm.

19. The sexual stimulation device according to claim 18, wherein the first clamper comprises a first shell sleeved on the first transmission portion of the first transmission shaft and a second motor accommodated in the first shell, and the second clamper comprises a second shell sleeved on the second transmission portion of the second transmission shaft and a third motor accommodated in the second shell, the first shell and the second shell are is covered by the covering member.

20. The sexual stimulation device according to claim 19, wherein the main body is made of a first material having a first hardness, the first shell and the second shell are is made of a second material having a second hardness, the covering member is made of a third material having a third hardness, and wherein, the second hardness is less than the first hardness, and the third hardness is less than the second hardness.

21. A sexual stimulation device which is insertable into a vagina of a female along an insertion direction, the sexual stimulation device comprising:
a main body comprising a handle portion;
an insertable arm configured for protruding from the main body and extending along a longitudinal direction of the sexual stimulation device, wherein the longitudinal direction is parallel to the insertion direction;
a first clamper disposed at a side of the insertable arm;
a second clamper spaced apart from and oppositely arranged to the first clamper, wherein the first clamper and the second clamper are configured to substantially remain outside a vagina while the elongated arm is inserted into the vagina; and
a driving mechanism accommodated in at least one of the main body and the insertable arm and configured for driving the insertable arm, the first clamper and the second clamper,
wherein the driving mechanism drives the insertable arm to move reciprocally to produce a first stimulation effect, and drives the first clamper and the second clamper to swing reciprocally along a lateral direction of the sexual stimulation device to produce a second stimulation effect.

22. The sexual stimulation device according to claim 21, wherein the insertable arm comprises a stimulation portion arranged at a distal end of the insertable arm away from the main body, and the stimulation portion is configured for moving telescopically relative to the main body, the stimulation portion of the insertable arm is driven to move away from the main body while the first clamper and the second clamper move towards each other, and the stimulation portion of the insertable arm is driven to move towards the main body while the first clamper and the second clamper move away from each other.

23. The sexual stimulation device according to claim 21, wherein the driving mechanism comprises a driving motor, a telescopic portion, a pusher, a first transmission shaft, and a second transmission shaft,
the telescopic portion is connected to the driving motor and coupled to the insertable arm, the driving motor drives the telescopic portion to extend or retract along the longitudinal direction of the sexual stimulation device,
the pusher is slidably coupled to the telescopic portion and configured to move laterally in response to a longitudinal movement of the telescopic portion,
the first transmission shaft and the second transmission shaft are coupled to the pusher, at least a part of the first transmission shaft is inserted into the first clamper and at least a part of the second transmission shaft is inserted into the second clamper, and the first transmission shaft and the second transmission shaft are configured to be driven by the pusher to cause the first and second clampers to swing at a programmable frequency for vaginal stimulation.
